(19) United States
(12) Patent Application Publication
(10) Pub. No.: US 2012/0293867 A1
(43) Pub. Date: Nov. 22, 2012

(54) POLARIZATION MODULE AND IMAGE DISPLAY APPARATUS

(76) Inventor: Norihiro MATSUYAMA, Kanagawa (JP)

(21) Appl. No.: 13/470,853

(22) Filed: May 14, 2012

(30) Foreign Application Priority Data
May 18, 2011 (JP) 2011-111847

(51) Int. Cl. G02B 27/26; G02B 5/30

(52) U.S. Cl. 359/465; 359/489.07

(57) ABSTRACT

A polarization module includes: a polarizer; a plurality of first quarter-wave plates disposed over the polarizer such that their optical axes are tilted at 45 degrees with respect to the polarization axis of the polarizer; and a plurality of second quarter-wave plates disposed over the polarizer such that their optical axes are tilted at 45 degrees with respect to the polarization axis of the polarizer in the direction opposite to the tilting direction of the optical axes of the first quarter-wave plates.

### FIELD

The present disclosure relates to a polarization module for displaying a three-dimensional image and an image display apparatus utilizing the module.

### BACKGROUND

Recently, image display apparatuses for providing three-dimensional images are being developed. Such an image display apparatus displays an image associated with each of the left and right eyes of a viewer based on parallax between the eyes. For example, the viewer can view a three-dimensional image by wearing glasses, i.e., lenses for the right and left eyes of the viewer provided with a filter for selectively transmitting light from the image for the right eye and a filter for selectively transmitting light from the image for the left eye, respectively.

For example, the image for the right eye and the image for the left eye are displayed based on beams of light which are polarized in different directions such that each beam can be selected by either of the above-described filers (for example, see JP-A-2004-109528 (Patent Document 1)).

For example, Patent Document 1 has disclosed the use of two types of linearly polarized light polarized in directions which are 90 degrees different from each other to provide images for the right and left eyes of a viewer separately.

Specifically, light from a liquid crystal panel is converted into linearly polarized light by a polarizer. Next, a part of the linearly polarized light is transmitted through a retardation film to rotate the polarization direction of the light at 90 degrees to provide, for example, light of an image for the right eye. On the contrary, the rest of the linearly polarized light is not transmitted through the retardation film, and the light undergoes no change in the polarization direction thereof, the light being rendered as an image for the left eye. Thus, the viewer is presented with light of an image for the right eye and light of an image for the left eye which are polarized in directions 90 degrees different from each other.

The viewer may view a three-dimensional image by wearing glasses, i.e., a lens for the right eye and a lens for the left eye on which a polarization filter transmitting linearly polarized light for the right eye only and a polarization filter transmitting linearly polarized light for the left eye only are disposed, respectively.

JP-A-2005-173033 (Patent Document 2) has disclosed the use of such a retardation film (wave plate filter) disposed in the form of a strip in association with every other horizontal line of pixels of a liquid crystal display unit.

### SUMMARY

As thus described, an image display apparatus for presenting a three-dimensional image must have members such as a polarizer and a retardation film as described above for obtaining light beams for left and right eyes separately which are not provided in two-dimensional image display apparatus according to the related art.

Such members must have high endurance against the environment thereof because they are disposed on an image display surface of an image display apparatus.

Under the circumstance, it is desirable to provide a polarization module having high endurance against the environment thereof and an image display apparatus having such a module.

An embodiment of the present disclosure is directed to a polarization module including: a polarizer and a plurality of first quarter-wave plates disposed on over the polarizer such that their optical axes are tilted at 45 degrees with respect to the polarization axis of the polarizer.

The polarization module according to the embodiment of the present disclosure includes a plurality of second quarter-wave plates disposed over the polarizer such that their optical axes are tilted at 45 degrees with respect to the polarization axis of the polarizer in the direction opposite to the tilting direction of the optical axes of the first quarter-wave plates.

Another embodiment of the present disclosure is directed to an image display apparatus including a display panel having a first pixel region for displaying an image associated with parallax of a right eye and a second pixel region for displaying an image associated with parallax of a left eye and including the above-described polarization module disposed on the display panel.

The first quarter-wave plates are disposed to face the first pixel region of the display panel, and the second quarter-wave plates are disposed to face the second pixel region of the display panel.

In the polarization module and the image display apparatus according to the embodiments of the present disclosure, all of the quarter-wave plates are disposed on a single polarizer.

The polarization module and the image display apparatus according to the embodiments of the present disclosure can be provided with high anti-humidity performance, they can provide images of high quality.

### BRIEF DESCRIPTION OF THE DRAWINGS

FIGS. 1A, 1B, and 1C are schematic views of a polarization module according to a first embodiment of the technique disclosed herein showing a configuration of the module;

FIG. 2 is an illustration of the polarization module according to the first embodiment of the technique disclosed herein and a display panel;

FIG. 3 is a schematic view of a polarization module as a comparative example showing a configuration thereof;

FIGS. 4A, 4B, and 4C are schematic views of a polarization module according to a second embodiment of the technique disclosed herein showing a configuration of the module; and

FIG. 5 is a perspective view of an image display apparatus according to a third embodiment of the technique disclosed herein.

### DETAILED DESCRIPTION

Embodiments of the present disclosed technique will now be described. The technique of the present disclosure is not limited to the embodiments described below.

The following items will be described in the order listed.

1. First Embodiment (Embodiment Having One-Dimensionally Arranged Wave Plates)

2. Second Embodiment (Embodiment Having Two-Dimensionally Arranged Wave Plates)

3. Third Embodiment (Embodiment of Image Display Apparatus)

### 1. First Embodiment

### Embodiment Having One-Dimensionally Arranged Wave Plates

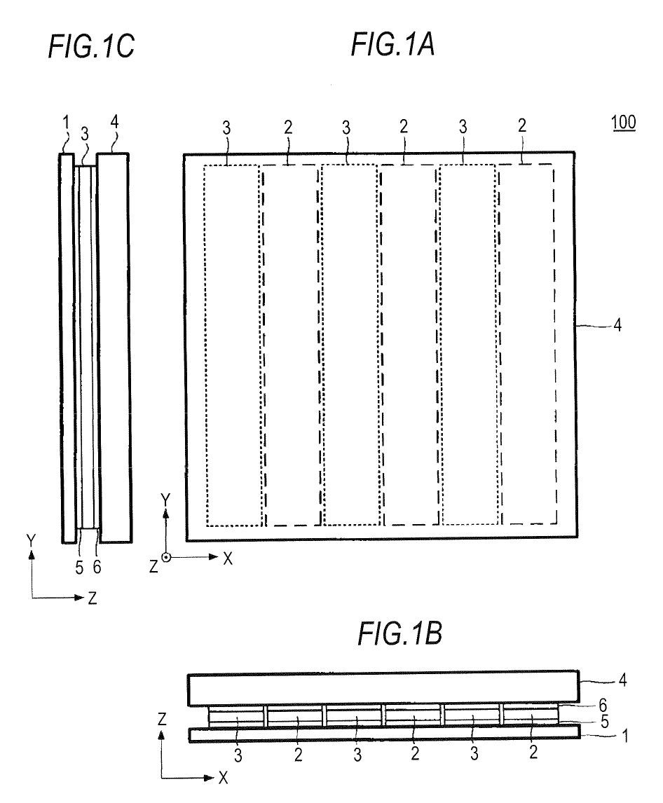

FIGS. 1A to 1C are schematic views of a polarization module 100 according to a first embodiment of the present disclosure showing a configuration thereof. FIG. 1A is a view of the polarization module 100 taken in a direction (a direction along Z-axis) perpendicular to one of principal surfaces of the module. FIG. 1B is a view of the polarization module 100 taken in a direction along Y-axis. FIG. 1C is a view of the polarization module 100 taken in a direction along X-axis.

The polarization module 100 of the present embodiment includes a polarizer 1 and a plurality of first wave plates 2 (first quarter-wave plates) and a plurality of second wave plates (second quarter-wave plates) disposed on one of principal surfaces of the polarizer 1.

There is no particular restriction on the polarizer 1 as long as it transmits light having a predetermined polarization direction only. For example, a typical polarizer used in image display apparatus is formed by a uniaxially oriented film and protective films applied to both sides of the film. The uniaxially oriented film is obtained from a resin which includes iodine and a dichroic substance such as a dichroic pigment and which is primarily composed of polyvinyl alcohol (PVA). The polarizer 1 of the present embodiment may be similar in configuration to such a typical polarizer.

The plurality of first wave plates 2 and the plurality of second wave plates 3 are disposed on one of principal surfaces of the polarizer 1. The first wave plates 2 and the second wave plates 3 are secured to the polarizer 1 through a bonding layer 5. The bonding layer 5 is formed by, for example, a light transmitting adhesive or a light transmitting adhesive tape.

Identical quarter-wave plates may be used as the first wave plates 2 and the second wave plates 3.

The first wave plates 2 are disposed such that their optical axes are tilted at an angle of +45 degrees with respect to the polarization axis (slow axis) of the polarizer 1. The second wave plates 3 are disposed such that their optical axes are tilted at an angle of −45 degrees with respect to the polarization axis of the polarizer 1. That is, the second wave plates 3 are disposed such that their optical axes are tilted at an angle of 45 degrees with respect to the polarization axis of the polarizer 1 in the direction opposite to the direction in which the first wave plates 2 are tilted.

Therefore, the second wave plates 3 are identical to the first wave plates 2 except that they are disposed on the polarizer 1 such that they appear upside down compared to the first wave plates 2.

As shown in FIG. 1A, each of the first wave plates 2 and the second wave plates 3 has a rectangular principle surface, and the first wave plates 2 and the second wave plates 3 are arranged such that they alternate in the extending direction of the shorter sides of the wave plates.

A light transmitting cover panel 4 is disposed on the plurality of the first wave plates 2 and the plurality of the second wave plates 3. For example, a light transmitting plastic substrate or a glass substrate may be used as the cover panel 4. The cover panel 4 is secured to the first wave plates 2 and the second wave plates 3 through a bonding layer 6. The bonding layer 6 may be of the same material as that used for the bonding layer 5.

The cover panel 4 disposed on the first wave plates 2 and the second wave plates 3 provides the polarization module with a planar top surface and allows the first wave plates 2 and the second wave plates 3 to be protected.

An anti-reflection process such as provision of an anti-reflection film may be carried out on a principal surface of the cover panel 4 which is opposite to the side of the panel facing the polarizer 1.

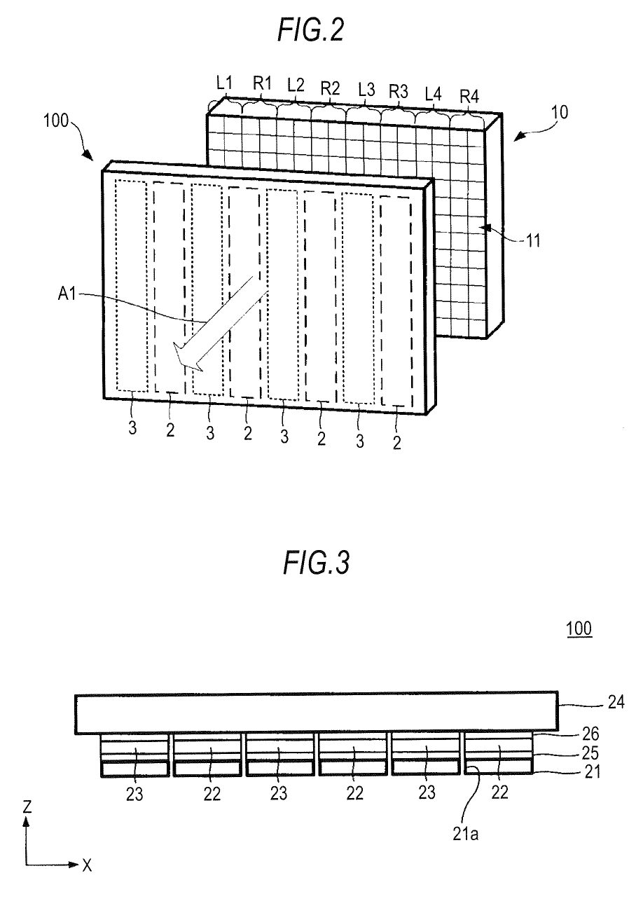

As shown in FIG. 2, the polarization module 100 is mounted over an image display surface of a display panel 10. At this time, the polarization module 100 is disposed such that the polarizer 1 of the module faces the display panel 10. Light emitted from the display panel 10 is transmitted through the polarization module 100 as indicated by an arrow A1 to reach the eyes of a viewer.

For example, pixels 11 in three primary colors red (R) green (G), and blue (B) are disposed in the form of a matrix on the image display surface of the display panel 10. The pixels 11 may be liquid crystal display pixels, and the pixels may alternatively be constituted by LEDs (light emitting diodes) when a display screen having a great surface area is to be formed.

Among the pixels 11, the pixels arranged in first pixel regions or columns R1 to R4 display an image for the right eye of a viewer, and the pixels arranged in second pixel regions or columns L1 to L4 display an image for the left eye.

Since the polarization module 100 is disposed over the display panel 10, for example, the first wave plates 2 are disposed over the first pixel regions or the columns R1 to R4, and the second wave plates 3 are disposed over the second pixel regions or the columns L1 to L4.

FIGS. 1A to 1C and FIG. 2 schematically show the polarization module 100 and the display panel 10, and the size and the number of each of the constituent members such as the first wave plates 2, the second wave plates 3, and the pixels 11 may be changed as occasion demands.

Light emitted from the pixels disposed in the first pixel regions or the columns R1 to R4 is transmitted through the polarizer 1 of the polarization module 100 to become linearly polarized light, and the light thereafter impinges on the first wave plates 2. Since the optical axes of the first wave plates 2 are tilted at 45 degrees with respect to the polarization axis of the polarizer 1, the light transmitted through the first wave plates 2 becomes circularly polarized light.

Light emitted from the pixels disposed in the second pixel regions or the columns L1 to L4 is transmitted through the polarizer 1 of the polarization module 100 to become linearly polarized light, and the light thereafter impinges on the second wave plates 3. Since the optical axes of the second wave plates 3 are tilted at 45 degrees with respect to the polarization axis of the polarizer 1 in the direction opposite to the direction in which the optical axes of the first wave plates 2 are tilted. Therefore, the light transmitted through the second wave plates 3 becomes circularly polarized light having a rotating direction opposite to the rotating direction of the light transmitted through the first wave plates 2.

As thus described, the light emitted from the pixels disposed in the first pixel regions or the columns R1 to R4 and the light emitted from the pixels disposed in the second pixel regions or the columns L1 to L4 become circularly polarized light beams having rotating direction opposite to each other by being transmitted through the polarization module 100.

A viewer can view a three-dimensional image by wearing glasses including a circularly polarized light filter transmitting circularly polarized light from the pixel regions of the columns L1 to L4 disposed in association with the left eye and a circularly polarized light filter transmitting circularly polarized light from the pixel regions of the columns R1 to R4 disposed in association with the right eye.

As shown in FIGS. 1A to 1C, all of the first wave plates 2 and the second wave plates 3 of the polarization module 100 of the present embodiment are disposed on the single polarizer 1.

FIG. 3 shows a case in which a plurality of polarizers are disposed on a plurality of wave plates corresponding thereto respectively as a comparative example. The shape of principal surfaces of each polarizer is the same as the shape of the wave plates.

In a polarization module 110 shown in FIG. 3, first wave plates 22 and second wave plates 23 are secured to a cover panel 24 through a bonding layer 26. Those features are similar to the first wave plates 2, the second wave plates 3, and the cover panel 4 shown in FIGS. 1A to 1C.

In this comparative example, the plurality of separate polarizers 21 are bonded to the first wave plates 2 and the second wave plates 3 in a one-to-one relationship through bonding layers 25.

When a plurality of polarizers are disposed as thus described, the total area of edge regions of the polarizers 21 such as a surface 21a is great. Then, the polarizers 21 are likely to start deteriorating at edge regions thereof.

One of resin materials making up a common polarizer is polyvinyl alcohol, and polyvinyl alcohol is very highly hydrophilic. When the total area of edge regions of the polarizers 21 is great, polyvinyl alcohol can be eluted into water droplets and the like from edge regions of the polarizers 21 in an environment having high humidity, which can result in deterioration of the polarizers 21.

In the polarization module 100 of the present embodiment, all of the first wave plates 2 and the second wave plates 3 are disposed on the single polarizer 1. Since the area of edge regions of the polarizer 1 can therefore be kept small, it is possible to prevent water-soluble components such as polyvinyl alcohol from being eluted into water from the edge regions. Thus, the module can be provided with high anti-humidity properties.

Since the polarization module 100 includes only one polarizer 1, the polarization module 100 can be provided with a planar surface and high mechanical strength as a module.

### 2. Second Embodiment

### Embodiment Having Two-Dimensionally Arranged Wave Plates

Depending on the arrangement of the pixels for left and right eyes of the display panel, changes may be made on the shape of the wave plates and the pattern in which the wave plates are disposed.

An exemplary case in which first and second wave plates are disposed in the form of a matrix (or in a checkerboard pattern) will now be described.

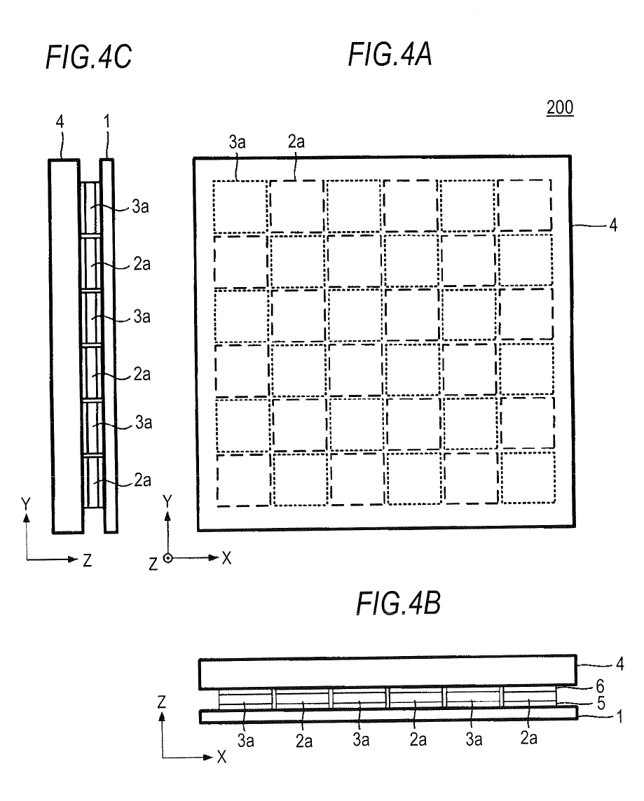

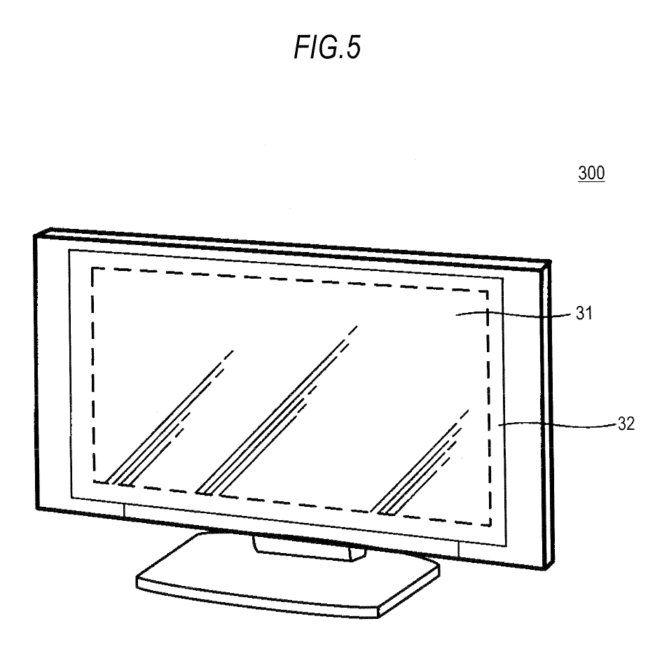

FIGS. 4A to 4C are schematic views of a polarization module 200 according to a second embodiment of the present disclosure showing a configuration thereof. FIG. 4A is a view of the polarization module 200 taken in a direction (a direction along Z-axis) perpendicular to one of principal surfaces of the module. FIG. 4B is a view of the polarization module 200 taken in a direction along Y-axis. FIG. 4C is a view of the polarization module 200 taken in a direction along X-axis.

A feature which is identical between the present embodiment and the first embodiment (see FIGS. 1A to 1C) will be indicated by the same reference numeral and will not be described to avoid duplicated description.

The polarization module 200 of the present embodiment includes one polarizer 1, first wave plates 2a, second wave plates 3a, and a cover panel 4. The features listed and bonding layers 5 and 6 for bonding the features may be basically similar in configuration to the polarizer 1, the first wave plates 2, the second wave plates 3, the cover panel 4, and the bonding layers 5 and 6 of the first embodiment, respectively. The shape and arrangement of the first wave plates 2a and the second wave plates 3a of the present embodiment are different from the shape and arrangement of the respective features of the first embodiment.

For example, the first wave plates 2a and the second wave plates 3a have a square outline when viewed in a light-emitting direction (a direction along Z-axis). The first wave plates 2a and the second wave plates 3a are disposed in an in-plane direction of the polarizer 1 such that they alternate in each of two axial directions orthogonal to each other (directions along X and Y axes of FIGS. 4A to 4C). That is, the first wave plates 2a and the second wave plates 3a are arranged in a so-called checkerboard pattern.

Such a polarization module 200 is mounted to a display panel having pixel regions for displaying an image for the left eye of a viewer and pixel regions for displaying an image for the right eye, the two types of pixel regions being arranged in a checkerboard pattern in a manner similar to that described above. The number of pixels to be allocated to one first wave plate 2a, and the number of pixels to be allocated to one second wave plate 3a may be set as desired. The size of the first wave plates 2a and the second wave plates 3a is determined according to the size of respective pixel regions of the display panel.

In the polarization module 200 of the present embodiment, all of the first wave plates 2a and the second wave plates 3a are disposed on the single polarizer 1. Since the area of edge regions of the polarizer 1 can therefore be kept small, the polarization module 200 can be provided with high anti-humidity performance.

The present embodiment provides other advantages which are similar to those of the first embodiment.

### 3. Third Embodiment

### Embodiment of Image Display Apparatus

FIG. 5 is a perspective view of an image display apparatus 300 according to a third embodiment of the present disclosure. The image display apparatus 300 of the present embodiment includes a polarization module 32 disposed on an image display section 31 thereof.

The image display section 31 is constituted by, for example, a display panel 10 as described above as the first embodiment of the present disclosure (see FIG. 2). For example, the image display section 31 includes pixel areas which are defined at intersections between a plurality of scan lines and a plurality of signal lines disposed to extend in a direction orthogonal to the scan line, one pixel area being allocated to each intersection. At each pixel, for example, a semiconductor device for driving the pixel is disposed.

For example, the scan lines are connected to a scan line driving circuit which is not shown, and the semiconductor devices are turned on by a pulse voltage supplied from the scan line driving circuit.

When the semiconductor devices are turned on, video signals according to luminance information is supplied from a signal driving circuit to light emitting elements such as LEDs. The light emitting elements emit light with luminance according to current values of the video signals to display images.

Light emitting elements provided in the pixel regions of the display panel 10 for displaying images for the right and left eyes of a viewer are supplied with respective video signals associated with the images for the right and left eyes from the signal driving circuit.

For example, the polarization module 100 described as the first embodiment (see FIGS. 1A to 1C) or the polarization module 200 described as the second embodiment (see FIGS. 4A to 4C) may be used as the polarization module 32.

In the polarization module 100 or 200, since all wave plates are disposed on one polarizer as described above, the area of edge regions of the polarizer can be kept small. The image display apparatus 300 of the present embodiment employs a polarization module 100 or 200 as thus described, and the apparatus can therefore be provided with high anti-humidity performance and can provide three-dimensional images of high quality.

Embodiments of the polarization module and the image display apparatus according to the present disclosure have been described. The technique of the present disclosure is not limited to the embodiments, and the technique may be implemented in various alternative modes without departing from the spirit of the present disclosure.

The technique of the present disclosure may be implemented as the following configurations.

(1) A polarization module including:

a polarizer;

a plurality of first quarter-wave plates disposed over the polarizer such that their optical axes are tilted at 45 degrees with respect to the polarization axis of the polarizer; and

a plurality of second quarter-wave plates disposed over the polarizer such that their optical axes are tilted at 45 degrees with respect to the polarization axis of the polarizer in the direction opposite to the tilting direction of the optical axes of the first quarter-wave plates.

(2) The polarization module according to (1), wherein the first wave plates and the second wave plates may be in the form of rectangles and may be disposed alternately in a direction along the minor axis of the rectangles.

(3) The polarization module according to (1), wherein the first wave plates and the second wave plates may be alternately disposed in a checkerboard pattern.

(4) The polarization module according to (1), which further includes a cover panel disposed on the first quarter-wave plates and the second quarter-wave plates.

(5) An image display apparatus including:

a display panel having a first pixel region for displaying an image for a right eye and a second pixel region for displaying an image for a left eye; and

a polarization module disposed over the display panel and having polarizer, a plurality of first quarter-wave plates disposed over the polarizer such that their optical axes are tilted at 45 degrees with respect to the polarization axis of the polarizer, and a plurality of second quarter-wave plates disposed over the polarizer such that their optical axes are tilted at 45 degrees with respect to the polarization axis of the polarizer in the direction opposite to the tilting direction of the optical axes of the first quarter-wave plates, wherein

the display panel is mounted to a surface of the polarizer opposite to the side on which the first quarter-wave plates and the second quarter-wave plates are disposed;

the plurality of first quarter-wave plates are disposed to face the first pixel region of the display panel; and

the plurality of second quarter-wave plates are disposed to face the second pixel region of the display panel.

The present disclosure contains subject matter related to that disclosed in Japanese Priority Patent Application JP 2011-111847 filed in the Japan Patent Office on May 18, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A polarization module comprising:
a polarizer;
a plurality of first quarter-wave plates disposed on over the polarizer such that their optical axes are tilted at 45 degrees with respect to the polarization axis of the polarizer; and
a plurality of second quarter-wave plates disposed over the polarizer such that their optical axes are tilted at 45 degrees with respect to the polarization axis of the polarizer in the direction opposite to the tilting direction of the optical axes of the first quarter-wave plates.

2. The polarization module according to claim 1, wherein the first quarter-wave plates and the second quarter-wave plates have principal surfaces which are in the form of rectangles and are disposed alternately in a direction along the minor axis of the rectangles.

3. The polarization module according to claim 1, wherein the first quarter-wave plates and the second quarter-wave plates are alternately disposed in the form of a matrix.

4. The polarization module according to claim 2, further comprising a cover panel disposed on the plurality of first quarter-wave plates and the plurality of second quarter-wave plates.

5. An image display apparatus comprising:
a display panel having a first pixel region for displaying an image for a right eye and a second pixel region for displaying an image for a left eye; and
a polarization module disposed over the display panel and having polarizer, a plurality of first quarter-wave plates disposed over the polarizer such that their optical axes are tilted at 45 degrees with respect to the polarization axis of the polarizer, and a plurality of second quarter-wave plates disposed over the polarizer such that their optical axes are tilted at 45 degrees with respect to the polarization axis of the polarizer in the direction opposite to the tilting direction of the optical axes of the first quarter-wave plates, wherein:
the display panel is mounted to a surface of the polarizer opposite to the side on which the first quarter-wave plates and the second quarter-wave plates are disposed;
the plurality of first quarter-wave plates are disposed to face the first pixel region of the display panel; and
the plurality of second quarter-wave plates are disposed to face the second pixel region of the display panel.
